(19) United States
(12) Patent Application Publication
(10) Pub. No.: US 2004/0171467 A1
(43) Pub. Date: Sep. 2, 2004

(54) Yarn guide roll

(75) Inventor: Heiner Kudrus, Barmstedt (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Barmag AG

(21) Appl. No.: 10/647,624

(22) Filed: Aug. 25, 2003

Related U.S. Application Data
(63) Continuation of application No. PCT/EP02/01643, filed on Feb. 15, 2002.

(30) Foreign Application Priority Data
Feb. 23, 2001 (DE) 101 08 690.3

(51) Int. Cl. G03G 19/00

(52) U.S. Cl. 492/8

(57) ABSTRACT

A roll for guiding at least one yarn in a yarn processing operation and comprising a tubular roll sleeve which is mounted for free rotation on a support by a plurality of bearings. At least one of the bearings is constructed as a radially operative magnetic bearing, which comprises a plurality of bearing pole windings distributed in the circumferential direction of the roll sleeve and which have predetermined pole cross sections. At least one of the bearing pole windings has a pole cross section which is larger or smaller than the pole cross sections of one or more of the other bearing pole windings, so as to permit the load profile imparted to the sleeve by a running yarn to be balanced over the circumference of the sleeve.

### CROSS REFERENCE TO RELATED APPLICATION

The present application is a continuation of international application PCT/EP02/01643 filed 15 Feb. 2002, and designating the U.S. The disclosure of that application is incorporated herein by reference.

### BACKGROUND OF THE INVENTION

The present invention relates to a roll for guiding at least one running yarn in a yarn processing operation.

In spinning lines or textile machines, rolls of different types and shapes are used to guide one or more yarns. Rolls of this type are thus used as godets for guiding, drawing, or heating yarns. Likewise known are rolls, which serve as contact rolls and guide the yarn while being wound to a package surface. Common to all referenced rolls is that the roll sleeve is rotatably supported for being operated at a circumferential speed, which may largely correspond to the yarn speed. To this end the roll sleeve is mounted on a support by means of a bearing.

EP 0 770 719 B1 and DE 197 33 239 A1 disclose rolls of the described type which are in the form of godets, in which the roll sleeve is magnetically supported. To this end, at least one radially operative magnetic bearing is provided, which comprises a plurality of bearing pole windings that are distributed along the support. The bearing pole windings are evenly distributed over the circumference of the roll sleeve, so that a substantially identical bearing force is operative in each point of the circumference for supporting the roll sleeve.

However, with the known rolls, a problem can arise in that the load on the roll sleeve is unevenly distributed over the circumference because of a partial yarn looping. Thus, a yarn looping of less than 180° generates a statically unilateral load on the roll sleeve. To absorb such loads on the roll sleeve by corresponding bearing forces, an overdimensioning of the bearing pole windings is inevitable for purposes of avoiding a complex control. In this connection, the differently operative load on the roll sleeve in the circumferential direction leads to the risk that the roll sleeve vibrates.

It is an object of the invention to further develop a roll of the initially described type such that the bearing forces which are generated for supporting the roll sleeve, can be largely adapted to a load profile that is operative on the circumference of the roll sleeve.

A further object of the invention is to lessen the risk of deformations by resonance vibrations on the roll.

### SUMMARY OF THE INVENTION

The invention is based on the fact that the force of a magnet is dependent, among other things, on the surface of the pole cross section. This provides the possibility of obtaining in a simple manner modified magnetic forces for supporting the roll sleeve by changing the size of the pole cross sections. To this end, the roll of the invention possesses at least one radially operative magnetic bearing, in which one of the bearing pole windings has a pole cross section that is larger or smaller than the pole cross sections of the other bearing pole windings. Thus, there exists the possibility of generating for the support of the roll sleeve, different magnetic forces that are distributed over the circumference of the roll sleeve, while supplying the same current to all bearing pole windings.

To be able to realize a bearing mount of the roll sleeve that is adapted to the operating condition of the roll, a further embodiment of the invention will be especially advantageous, wherein the arrangement of the bearing pole windings or the sizes of the cross sections of the bearing pole windings are selected as a function of the load that is operative on the roll sleeve. Especially advantageous is the combination between the size of the pole cross sections of the bearing pole windings and their arrangements on the support for mounting the roll sleeve.

In the case where the radially operative magnetic bearing mount of the roll sleeve is based on attracting magnetic forces, a further advantageous embodiment of the invention provides that one of the bearing pole windings or a plurality of bearing pole windings with a smaller pole cross section are arranged in the circumferential region of the roll sleeve, in which the load is directly introduced into the roll sleeve. For example, when using the roll as a contact roll in a takeup device, it is possible to use the magnetic bearing with advantage for absorbing the contact forces that are statically operative on the packages.

It is preferred to design radially operative magnetic bearings on the basis of attracting magnetic forces, so that the bearing pole winding or a plurality of bearing pole windings with a larger pole cross section are preferably arranged in the circumferential region of the roll sleeve, which faces the circumferential region of the roll sleeve where the load is directly introduced into the roll sleeve.

An advantageous further development of the invention has the advantage that the arrangement of the bearing pole windings in a plurality of bearing planes leads to an equalization of the distribution of positions into which the force is introduced for a radial bearing mount of the roll sleeve. With that it becomes possible to achieve in addition to the high carrying capacity, a rigidity of the bearing mount, which reduces in particular in the case of long projecting rolls, the tendency of the rolls to deform at high speeds, for example, to bend in the case of resonance vibrations. Because of the greater rigidity, it becomes possible to make rolls with less mass and, thus, with higher inherent frequencies.

According to an advantageous further development of the invention, it is possible to arrange at least some of the bearing pole windings with an angular displacement from bearing plane to bearing plane. With that, the directions vary from which the bearing forces are exerted onto the roll sleeve. This enables a radial bearing mount of the roll sleeve with an arrangement of only one or two bearing pole windings in one bearing plane and, if need be, with a plurality of bearing planes. In this instance, it is necessary that the bearing pole windings of different bearing planes cooperate. As a result of the angularly displaced arrangement of the bearing pole windings from bearing plane to bearing plane, it is possible to further equalize the distribution of the bearing pole windings over the support.

An arrangement of the bearing pole windings in a bearing plane strengthens the surface character of the radial bearing mount of the roll sleeve. It can enable a further equalization and distribution of the bearing pole windings with different pole cross sections for absorbing static loads.

The arrangement of respectively two opposite bearing pole windings in a bearing plane is capable of enabling a uniform distribution of the bearing pole windings over the support, in particular for rolls with a large diameter. This arrangement is especially suited for realizing greater, surface-related bearing forces. In this connection, it is preferred to make the pole cross sections of opposite bearing pole windings of the same size.

To ensure the cooperation of all bearing pole windings of the magnetic bearing, an advantageous further development of the invention provides for associating to each of the bearing pole windings a sensor for monitoring a bearing gap or for monitoring the position of the roll sleeve. The sensors and the bearing pole windings connect to a control device, so that it is possible to correct each signaled bearing gap deviation immediately. In this process, the control device activates the bearing pole windings preferably individually. However, it is also possible to have the control device control a plurality of bearing pole windings of a bearing plane in paired relationship.

In the case of long rolls, it is preferred to support the roll sleeve in accordance with the further development of the invention, wherein two radially operative magnetic bearings are provided in spaced relationship with each other. For absorbing the axial forces, the roll sleeve is additionally supported in a thrust bearing. The thrust bearing could likewise be constructed as an axially operative magnetic bearing for obtaining a noncontacting guidance, so as to permit higher speeds of the roll sleeve.

### BRIEF DESCRIPTION OF THE DRAWINGS

In the following, several embodiments of the roll in accordance with the invention are described in greater detail with reference to the attached drawings, in which:

FIG. 1 is a somewhat schematic sectional view of a first embodiment of the roll according to the invention, taken parallel to and through the axis of rotation and showing the components of the roll that are material to the invention;

FIG. 2 is a sectional view taken perpendicular to the axis of rotation of the roll;

FIG. 3 is a somewhat schematic axially sectioned view of a further embodiment of the invention;

FIG. 4 is a plurality of sectional views of the embodiment of FIG. 3 taken along the several bearing planes; and

FIG. 5 is a schematic axially sectioned view of a further embodiment of the roll according to the invention.

### DETAILED DESCRIPTION OF THE PREFERRED EMBODIMENTS

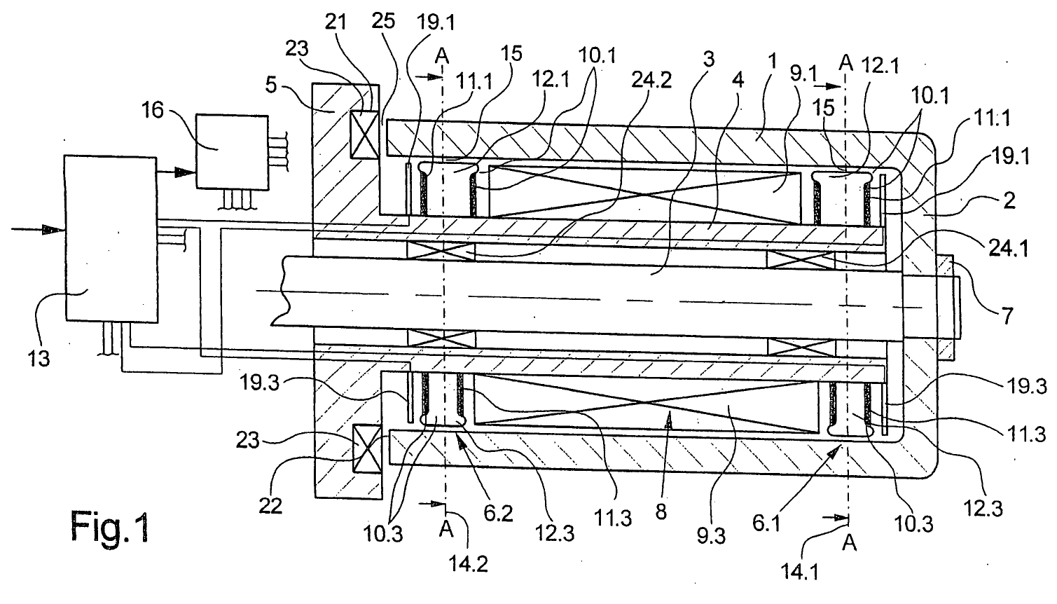

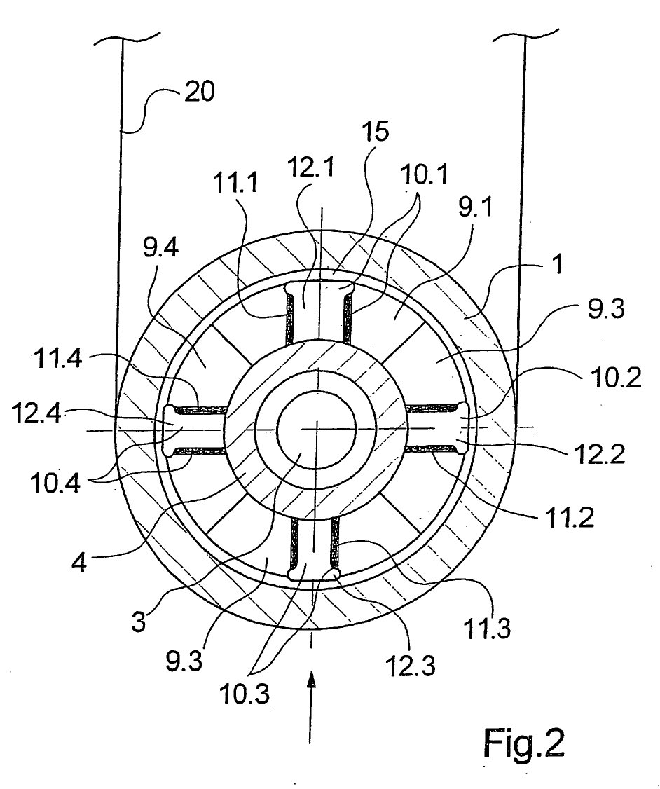

FIGS. 1 and 2 schematically illustrate a first embodiment of the roll according to the invention. The following description applies to both Figures, unless explicit reference is made to one of the Figures. The embodiment of the roll shown in these Figures comprises a tubular sleeve 1, which is connected for co-rotation via an end wall 2 to a drive shaft 3 that extends in the interior of the roll. To this end, the end of the drive shaft 3 mounts a clamping element 7 for securing the roll sleeve 1. With its opposite end, the shaft 3 connects to a drive (not shown). The drive could be provided, for example, by an electric motor.

The roll sleeve 1 is supported on a projecting support 4 by two radially operative magnetic bearings 6.1 and 6.2. The support 4 is made hollow-cylindrical or tubular and it extends inside the roll sleeve 1 almost as far as to the end wall 2. The shaft 3 extends coaxially through the tubular support 4. On its side opposite to the end wall 2, the support 4 is mounted via a collar 5 to a machine frame (not shown).

The magnetic bearings 6.1 and 6.2 are mounted in spaced relationship on the circumference of the support 4. The magnetic bearing 6.1 is located at one free end of the support 4, and the magnetic bearing 6.2 is located in the region of the rigidly mounted end of support 4. Between the magnetic bearings 6.1 and 6.2, a heating device 8 extends on the circumference of the support 4 for heating the roll sleeve 1. The heating device 8 comprises a plurality of heating elements 9.1-9.4, which are evenly distributed on the support 4. The heating elements may be formed, for example, by one or more windings that cause the roll sleeve to heat by induction.

Each of the magnetic bearings 6.1 and 6.2 comprises four bearing pole windings 10.1-10.4, which are distributed on support 4 in a bearing plane 14.1 and 14.2 respectively. Each of the bearing pole windings comprises an excitation winding 11.1-11.4 and a pole element 12.1-12.4.

The bearing pole windings 10.2-10.4 of the respective magnetic bearings 6.1 and 6.2 are made identical in the construction of the excitation windings and pole elements. However, the bearing pole windings 10.1 of the magnetic bearings 6.1 and 6.2 include pole elements 12.1, which have a larger cross section than the pole elements 12.2-12.4. Accordingly, the excitation winding 11.1 is made larger in comparison with the excitation windings 11.2-11.4.

The bearing pole windings 10.1-10.4 of the magnetic bearings 6.1 and 6.2 are each distributed over the support 4 in a bearing plane 14 with an angular displacement. The angular displacement is respectively 90°. This situation is shown in FIG. 2, which is both a cross sectional view of the magnetic bearing 6.1 and a cross sectional view of the magnetic bearing 6.2. The bearing pole winding 10.1 with the larger pole cross section of the pole element 12.1 is associated in the case of magnetic bearing 6.1 and in the case of magnetic bearing 6.2 to a circumferential range of the roll sleeve 1, which is opposite to a circumferential range that is looped by a yarn 20, as shown in FIG. 2. In this instance, the bearing pole windings 10.1 of magnetic bearings 6.1 and 6.2 are identical in their angular position on the support 4.

Between each of the bearing pole windings 10.1-10.4 of magnetic bearings 6.1 and 6.2 and the roll sleeve 1, a bearing gap 15 is formed. In the region of bearing planes 14.1 and 14.2, the roll sleeve 1 is made ferromagnetic, so that a magnetic force can be generated between the bearing pole windings and the roll sleeve 1. The bearing gaps 15 are monitored by sensors.

One sensor is associated to each bearing pole winding. More particularly, the sensors 19.1-19.4 of magnetic bearings 6.1 and 6.2 connect via signaling lines to a bearing control unit 13. The bearing control unit 13 connects via an energy supply unit to the bearing pole windings 10.1-10.4 of the magnetic bearings 6.1 and 6.2.

As can be noted from the illustration of FIG. 1, the diameter of collar 5 of the support 4 is larger than the diameter of roll sleeve 1. Toward the roll sleeve 1, the collar 5 of support 4 includes an annular groove 21, which accommodates a thrust bearing 23. The thrust bearing 23 is realized as an axially operative magnetic bearing, which forms an axial bearing gap 25 with an end face 22 of the roll sleeve 1.

In the interior of support 4 between shaft 3 and support 4, two backup bearings 24.1 and 24.2 are arranged in spaced relationship, thus ensuring a safe startup or an emergency run of the roll sleeve irrespective of the magnetic bearing mount. The use of backup bearings may include, for example, plain bearings or antifriction bearings.

The embodiment of the roll shown in FIGS. 1 and 2 is used in particular as a godet for advancing, heat treating, and drawing yarns. In this process, high tensile forces are generated in the yarns, which lead to a largely static load of the roll during the operation. The load is directly introduced into the circumferential range of the roll sleeve 1 that is looped by the yarn 20. To absorb the substantially unilaterally introduced tensile forces of the yarn, the bearing pole winding 10.1 in the magnetic bearings 6.1 and 6.2 generates a magnetic counterforce. The magnetic counterforce exerts an attraction on the roll sleeve 1, so that, as shown in FIG. 2, the bearing pole windings 10.1 are arranged on the side of the roll sleeve opposite to the load.

During operation, the actual location of the roll sleeve 1 is measured by the sensors 19.1-19.4 in the region of bearing planes 14.1 and 14.2, and the measured values are supplied to the bearing control unit 13. From the measured values, the bearing control unit 13 determines the location of the roll sleeve in the bearing planes 14.1 and 14.2 and activates the individual excitation windings 11.1-11.4 of the bearing pole windings 10.1-10.4 of magnetic bearings 6.1 and 6.2 in accordance with the desired correction of the location. It is preferred to activate the bearing pole windings of the magnetic bearings 6.1 and 6.2 individually, so that the location of the roll sleeve 1 maintains the desired position.

At the same time, the heating elements 9.1-9.4 of heating device 8 heat the roll sleeve 1. To control the surface temperature of the roll sleeve, one or more temperature sensors (not shown) are provided, which connect via signaling lines to a heat control unit and thus enable an adjustment of the surface temperature to a desired value.

In the embodiment shown in FIGS. 1 and 2, the radially operative magnetic bearings 6.1 and 6.2 are each formed in a bearing plane by several bearing pole windings. In this case, however, there also exists the possibility of distributing the bearing pole windings in several bearing planes. In addition, it is likewise possible to provide the sizes of the pole elements of the different bearing pole windings in different dimensions according to a load profile. Essential in this connection is the surface formed by the pole elements, which cooperates with the roll sleeve 1 for generating the magnetic forces.

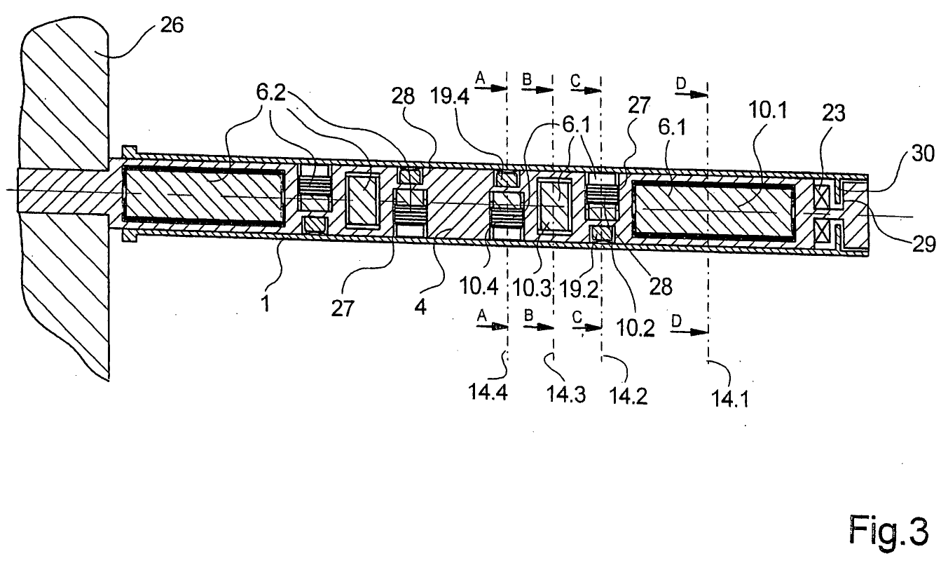

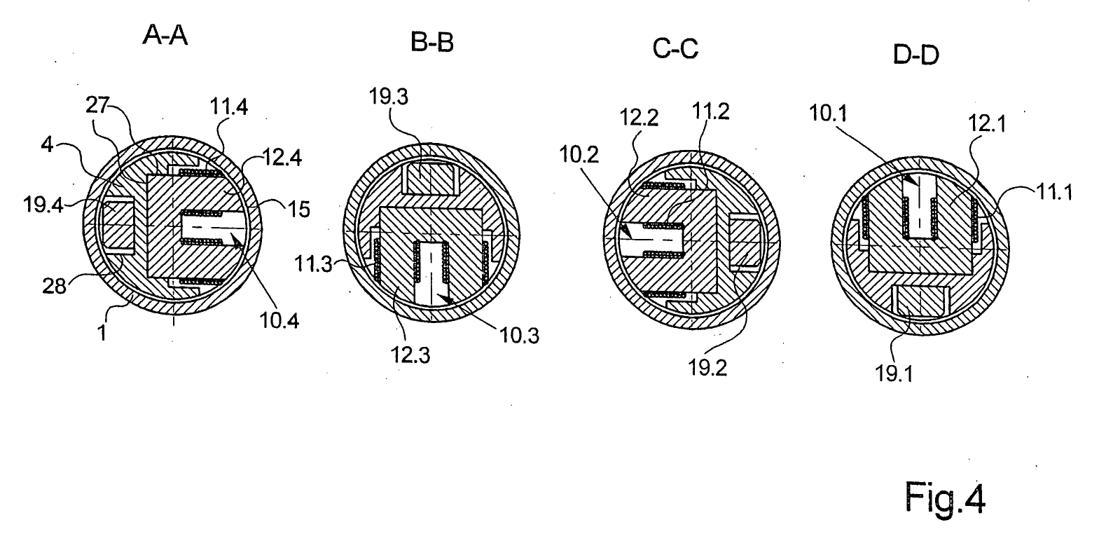

A further embodiment of a roll in accordance with the invention is shown in FIGS. 3 and 4, with FIG. 3 being a schematic, axially sectioned view of the embodiment, and FIG. 4 showing a plurality of cross sectional views thereof along the bearing planes. Components of the same function are provided with identical numerals.

In this case, the embodiment of the roll according to the invention possesses a long projecting non-tubular or solid support 4, which is unilaterally secured to a machine frame 26. The support 4 rotatably mounts the tubular roll sleeve 1. To support the roll sleeve 1, radially operative magnetic bearings 6.1 and 6.2 as well a thrust bearing 23 are provided. The magnetic bearing 6.1 comprises four bearing pole windings 10.1-10.4, which are arranged in spaced relationship with one another respectively in one of bearing planes 14.1-14.4. The bearing pole windings 10.1-10.4 are each arranged, 900 out of phase, on support 4. To this end, the support 4 comprises a plurality of cutouts 27, in which the bearing pole windings 10 are securely held.

The bearing pole windings 10.1-10.4 of magnetic bearing 6.1 differ in their size. Common to all bearing pole windings is that they require in the support 4 a cutout 27 that extends beyond the center axis of the support 4. As a result, it is possible to accommodate only one bearing pole winding in a bearing plane because of the limited assembly space. The bearing pole windings 10.1 and 10.4 have different pole cross sections. In comparison with the pole bearing windings 10.2-10.4, the bearing pole winding 10.1 is made with a substantially larger pole cross section for generating greater magnetic forces.

On the side of support 4 opposite to the cutout 27, a smaller cutout 28 is provided, which accommodates a sensor. Each of the bearing pole windings 10.1-10.4 is associated with a sensor 19.1-19.4 opposite thereto. In the present embodiment, the bearing pole windings 10.1-10.4 are formed, for example, by a U-shaped pole element 12, whose legs mount excitation windings 11.1-11.4. Each of the excitation windings of the bearing pole windings 10.1-10.4 connects together with the sensors 19.1-19.4 to a bearing control unit (not shown). Each of the bearing pole windings can be controlled independently of adjacent bearing pole windings.

In the region of the mount of support 4, the magnetic bearing 6.2 is likewise constructed with four bearing pole windings 10.1-10.4. The construction and arrangement of the bearing pole windings 10 correspond to magnetic bearing 6.1, so that at this point a more extensive description is omitted.

The free end of support 4 is provided with a peripheral groove 29, which is used to accommodate a thrust bearing 23. In the present embodiment, the thrust bearing 23 acts upon a peripheral projection 30, which is made integral with roll sleeve 1. The thrust bearing 23 is constructed as a magnetic bearing.

Each of the radially operative magnetic bearings 6.1 and 6.2 can be activated via a control device (not shown). In this connection, the excitation windings 11.1-11.4 of the bearing pole windings 10.1-10.4 within each magnetic bearing 6.1-6.2 are individually activated according to sensor signals in such a manner that a constant bearing gap 15 exists between the pole ends of the bearing pole windings and the roll sleeve 1.

This embodiment of the roll according to the invention is especially suited for receiving as a so-called guide roll in draw zones, a yarn advancing from a driven godet, so that the yarn can be supplied in several loopings to a drawing process or heat treatment. Normally, this type of rolls is constructed with a relatively small outside diameter. In this case, the bearing loads generated on the roll sleeve by the yarn looping are comparable with the driven godets. Consequently, the bearing pole windings 10.1 of the magnetic bearings 6.1 and 6.2 are made with larger pole cross sections of the pole elements 12.1 for absorbing the static loads that are caused by the yarns. With that, it becomes possible to generate greater magnetic forces that reliably absorb the loads occurring during the operation.

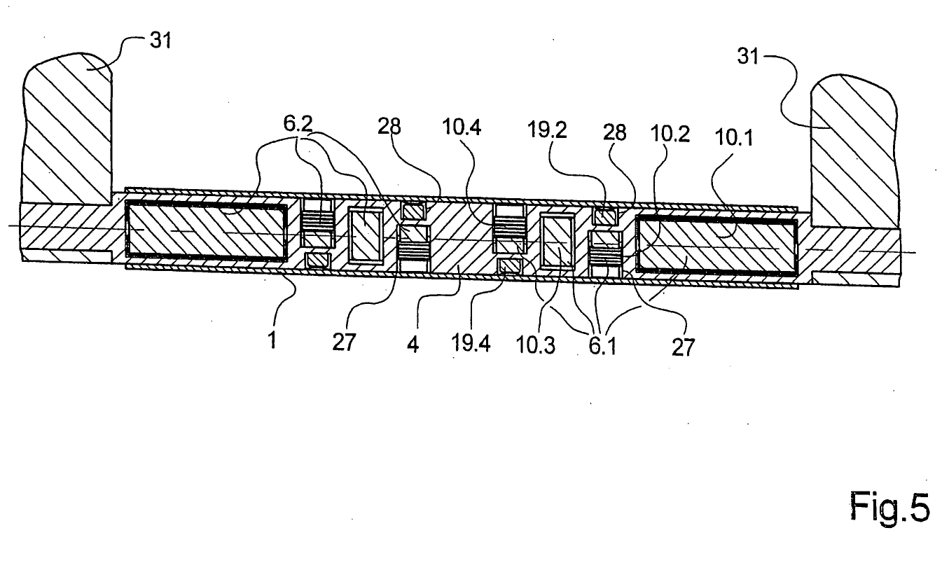

FIG. 5 illustrates a further embodiment of a non-driven roll, which is largely identical with the embodiment of FIGS. 3 and 4. To this extent, the foregoing description is herewith incorporated by reference, and only differences are described in the following.

At its two ends, the cylindrical support 4 stationarily connects to a rocker arm 31. The rocker arm 31 is pivotally mounted to a machine frame. The roll sleeve 1 is mounted for rotation on the circumference of support 4. To this end, the magnetic bearings 6.1 and 6.2 are arranged on the support 4. The magnetic bearings 6.1 and 6.2 are constructed identical with the foregoing embodiment.

To support the roll sleeve 1, the magnetic bearings 6.1 and 6.2 are controlled in such a manner that the bearing gap between the bearing pole windings 10.1-10.4 and the roller sleeve 1 remains substantially unchanged.

An axial bearing mount of the roll sleeve is not shown. The axial forces could also be absorbed, for example, by a corresponding configuration of the pole ends of the bearing pole windings. However, it is also possible to arrange in addition radial bearings or thrust bearings between the roll sleeve and the support 4.

It is preferred to use the embodiment of the roll as shown in FIG. 5 as a guide roll or so-called contact roll for depositing a yarn on a package. In this connection, the yarn advances over the circumference of the roll sleeve 1. In so doing, the roll sleeve is pressed against the package surface. The load, which is caused by the contact pressure, can be advantageously absorbed by the bearing pole windings of the magnetic bearings 6.1 and 6.2, which have a larger pole cross section.

The embodiments shown in FIGS. 1-5 are exemplary with respect to the construction of the radially operative magnetic bearings. Thus, there also exists the possibility of associating to each bearing pole winding an antipole for obtaining a bearing mount of the roll sleeve on the basis of attracting magnetic forces. In this instance, the bearing pole winding with the larger diameter is preferably placed in the peripheral range of the roll sleeve, into which the external load is directly introduced. Likewise, there exists the possibility of achieving by selecting several sizes of pole cross sections, an arrangement of the bearing pole windings, which counteracts in an optimized way a load profile that acts upon the circumference in a distributed manner.

1. A yarn guide roll for guiding at least one yarn on a circumferential surface thereof, comprising
an elongate support which defines a central axis,
a tubular roll sleeve,
a plurality of bearings rotatably mounting said tubular roll sleeve upon the support for rotation about said central axis,
at least one of said bearings comprising a radially operative magnetic bearing which comprises a plurality of bearing pole windings distributed about the circumference of the roll sleeve, with each bearing pole winding having a predetermined pole cross section, and wherein at least one of the bearing pole windings has a pole cross section which is larger or smaller than the pole cross section of at least one of the other bearing pole windings.

2. The yarn guide roll of claim 1, wherein the arrangement of the bearing pole windings and/or the sizes of the pole cross sections of the bearing pole windings are selected as a function of a load that acts upon the roll sleeve.

3. The yarn guide roll of claim 1, wherein the bearing pole winding or windings with a smaller pole cross section is or are arranged in a circumferential range of the roll sleeve, in which the load is directly introduced into the roll sleeve.

4. The yarn guide roll of claim 1, wherein the bearing pole winding or windings with the larger pole cross section is or are arranged in the circumferential range of the roll sleeve, which is opposite to the circumferential range of the roll sleeve, in which the load is directly introduced into the roll sleeve.

5. The yarn guide roll of claim 1, wherein the bearing pole windings are distributed along the support in a plurality of adjacent bearing planes.

6. The yarn guide roll of claim 5, wherein at least some of the bearing pole windings are distributed along the support with an angular displacement from bearing plane to bearing plane.

7. The yarn guide roll of claim 5, wherein the bearing pole windings are individually arranged in the bearing planes.

8. The yarn guide roll of claim 5, wherein the bearing pole windings are paired in facing relationship in the bearing planes.

9. The yarn guide roll of claim 1, wherein a sensor is associated with each of the bearing pole windings for detecting the position of the roll sleeve, and that the sensors and the bearing pole windings are connected to a bearing control unit.

10. The yarn guide roll of claim 9, wherein the bearing pole windings are each controllable by the bearing control unit.

11. The yarn guide roll of claim 1, wherein the roll sleeve is supported by two radially operative magnetic bearings and a thrust bearing, with the bearing pole windings of each of the magnetic bearings including at least one bearing pole winding with a larger or smaller pole cross section than that of at least one of the other bearing pole windings.

12. The yarn guide roll of claim 1, further comprising a heating device mounted between the support and the sleeve for heating the sleeve during operation of the roll.

13. The yarn guide roll of claim 12, wherein the heating device comprises an induction heater.

14. The yarn guide roll of claim 1, wherein the elongate support is tubular, and further comprising a drive shaft extending coaxially through the support and being attached to said sleeve.

15. The yarn guide roll of claim 1, wherein the elongate support is non-tubular and is fixed to a machine frame at at least one end of the support.
